(19) United States
(12) Patent Application Publication
(10) Pub. No.: US 2022/0044038 A1
(43) Pub. Date: Feb. 10, 2022

(54) USER ATTRIBUTE ESTIMATION DEVICE AND USER ATTRIBUTE ESTIMATION METHOD

(71) Applicant: Alpha Code Inc., Tokyo (JP)

(72) Inventor: Takuhiro MIZUNO, Tokyo (JP)

(21) Appl. No.: 17/424,341

(22) PCT Filed: Dec. 12, 2019
(86) PCT No.: PCT/JP2019/048639

§ 371 Date: Jul. 20, 2021

(30) Foreign Application Priority Data
Jan. 21, 2019 (JP) 2019-007969

(51) Int. Cl. G06K 9/00; G06Q 30/02; G06K 9/62; G06F 3/01

(52) U.S. Cl. CPC G06K 9/00892; G06Q 30/0269; G06F 3/011; G06K 9/6292; G06Q 30/0204

(57) ABSTRACT

A position sensing information acquisition unit that acquire a plurality of pieces of position sensing information from a position sensing sensor mounted on a body of a user or a position sensing sensor mounted on a controller held and used by the user, a physical feature recognition unit 12 that recognizes a physical feature of the body of the user from the plurality of pieces of position sensing information, and an attribute estimation unit 15 that estimates a user attribute from the recognized physical feature of the body of the user are provided, and the user attribute is estimated based on detection information by a sensor mounted on the body of the user who is watching the VR image or a sensor mounted on the controller held by the user, and thus the attribute of the user who is watching the VR image can be estimated even in a place at which no camera is installed.

### TECHNICAL FIELD

The present invention relates to a user attribute estimation device and a user attribute estimation method, and is particularly suitable for use in a device that estimates an attribute of a user who is watching a VR image.

### BACKGROUND ART

Nowadays, the use of virtual reality (VR) techniques that allow a virtual world created in a computer to be experienced as though the virtual world were real is spreading. Although there are various application examples of VR, in general, a user wears a head-mounted display (HMD) such as goggles and freely moves in a three-dimensional space (VR space) drawn as a three-dimensional image (VR image) with respect to the HMD by a computer, and thus the user can virtually experience various things. Instead of the goggle-type HMD, a glasses-type or hat-type HMD may be used. VR is also capable of presenting the user with a world beyond the realistic constraints of time and space.

Today, a movement to display an advertisement in a VR space is also spreading against the background of the spread of scenes used from VR. An advertisement displayed in the VR space is called a VR advertisement. Unlike conventional Internet advertisements using Internet websites or e-mails, the VR advertisement has representation methods that are not limited to a flat surface. The advertisement may be displayed on a flat surface on the VR space, or the advertisement can be deployed by making full use of the 360 degree VR space. As described above, although there is a difference in the representation method, it is desired to improve the advertising effect of the VR advertisement as much as possible similarly to the Internet advertisement. Therefore, a mechanism that displays an advertisement having contents matched with the attribute, interest, action, and the like of the user watching the VR image is devised (see, e.g. Patent Literature 1).

An information providing system described in Patent Literature 1 detects one or more attention objects to which a viewer pays attention in the VR image displayed on the HMD, ranks the attention objects in descending order of the degree of attention, and provides accompanying information associated with the attention objects to the user terminal according to the ranking. It should be noted that in the information providing system described in Patent Literature 1, detailed accompanying information corresponding to the attention objects of interest detected when a VR image is displayed on the HMD is provided to the user through a user terminal different from the HMD after the end or stop of reproduction of the VR image.

The information providing system described in Patent Literature 1 estimates an interest content of a user who is watching a VR image and displays an advertisement that is suitable for the interest content as accompanying information. To this, there is known a technique that analyzes an image of a user captured with a camera to estimate user attributes (body weight, age, sex, and the like) (see, e.g. Patent Literatures 2 and 3). It is also thought to display the VR advertisement determined according to the user attribute estimated using the techniques described in Patent Literatures 2 and 3.

Patent Literature 1: JP 2018-37755 A

Patent Literature 2: JP 2011-505618 A

Patent Literature 3: JP 2015-501997 A

### SUMMARY OF INVENTION

### Technical Problem

In the techniques described in Patent Literatures 2 and 3, since a captured image is used to estimate an attribute of a user, it is necessary to install a camera around the user who is watching a VR image. For example, a camera can be installed in a special exhibition venue, a shop, and the like. But, a camera is not installed in a typical place such as a home, so there are many cases in which capturing a user who is watching a VR image is not enabled from the outside. Therefore, there is a problem that the techniques described in Patent Literatures 2 and 3 could not be applied in many cases.

The present invention is made to solve such problems, and an object is to enable the estimation of an attribute of a user who is watching a VR image even in a place at which no camera is installed.

### Solution to Problem

In order to solve the above problem, in the present invention, a plurality of pieces of position sensing information is acquired from at least one of a position sensing sensor worn on a body of a user and a position sensing sensor mounted on a controller held and used by the user, physical features of the user body are recognized from the plurality of pieces of position sensing information, and a user attribute is estimated from the recognized physical features of the user body.

### Advantageous Effects of Invention

According to the present invention thus configured, the user attribute is estimated based on the detection information using the sensor mounted on the body of the user who is watching the VR image or the sensor mounted on the controller held by the user. Accordingly, the attribute of the user who is watching the VR image can be estimated even in a place at which no camera is installed.

### BRIEF DESCRIPTION OF DRAWINGS

FIG. 1 is a diagram illustrating an example of the configuration of a VR viewing system to which a user attribute estimation device according to the present embodiment is applied.

FIG. 2 is a block diagram illustrating an example of the functional configuration of an arithmetic unit including the user attribute estimation device according to the present embodiment.

FIG. 3 is a diagram for describing an example of processing contents of an attribute estimation unit according to the present embodiment.

FIG. 4 is a diagram for describing an example of processing contents of the attribute estimation unit according to the present embodiment.

FIG. 5 is a diagram for describing an example of processing contents of the attribute estimation unit according to the present embodiment.

### DESCRIPTION OF EMBODIMENTS

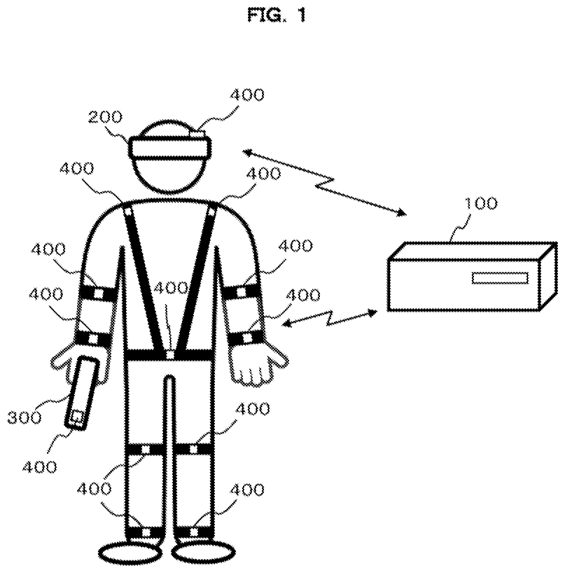

In the following, an embodiment of the present invention will be described with reference to the drawings. FIG. 1 is a diagram illustrating an example of the configuration of a VR viewing system to which a user attribute estimation device according to the present embodiment is applied. As illustrated in FIG. 1, the VR viewing system according to the present embodiment includes an arithmetic unit 100 including a functional configuration of a user attribute estimation device, a head mounted display (HMD) 200 used by being worn on the user's head, a controller 300 held and used by the user, and a plurality of sensors 400.

The HMD 200 may be any type. That is, the HMD 200 may be a binocular type or a monocular type. The HMD 200 may be a non-transmissive type that completely covers the eyes or may be a transmissive type. The HMD 200 may be any of a goggle type, a spectacle type, and a hat type. The controller 300 is used by the user to give a desired instruction to the arithmetic unit 100, and provided with a predetermined operation button.

One of the plurality of sensors 400 is mounted on the HMD 200. Another one of the plurality of sensors 400 is mounted on the controller 300. The remaining sensors 400 are attached to sites on the user body using a belt or the like. The sites on the user body on which the sensor 400 is worn through a belt or the like is a shoulder, an elbow, a wrist, a waist, a knee, an ankle, or the like. In the present embodiment, the sensor 400 includes a position sensing sensor and a motion sensing sensor. The sensor 400 mounted on the HMD 200 worn on the head of the user and the sensor 400 worn on the sites on the user body using a belt or the like correspond to a position sensing sensor and a motion sensing sensor “worn on the user body”.

The position sensing sensor is a known sensor including a light receiving sensor, for example. That is, the position sensing sensor receives a synchronization flash and an infrared laser emitted from a light emitting device (not illustrated) installed around the arithmetic unit 100 at regular intervals, detects a light receiving time and a light receiving angle, a reception time difference between the synchronization flash and the infrared laser, and the like, and wirelessly transmits the position sensing information to the arithmetic unit 100. Based on the position sensing information transmitted from the position sensing sensor, the arithmetic unit 100 calculates a position in the three-dimensional space in which the position sensing sensor is present (the position of the body part to which the position sensing sensor is attached).

The motion sensing sensor is a known sensor configured in the combination of an acceleration sensor, a gyro sensor, and the like. That is, the motion sensing sensor detects an acceleration and an angular velocity according to the direction and speed of motion of an object, a change in posture, and the like, and wirelessly transmits these pieces of motion sensing information to the arithmetic unit 100. Based on the motion sensing information transmitted from the motion sensing sensor, the arithmetic unit 100 calculates the motion of the motion sensing sensor in the three-dimensional space (the motion of the body part on which the motion sensing sensor is worn).

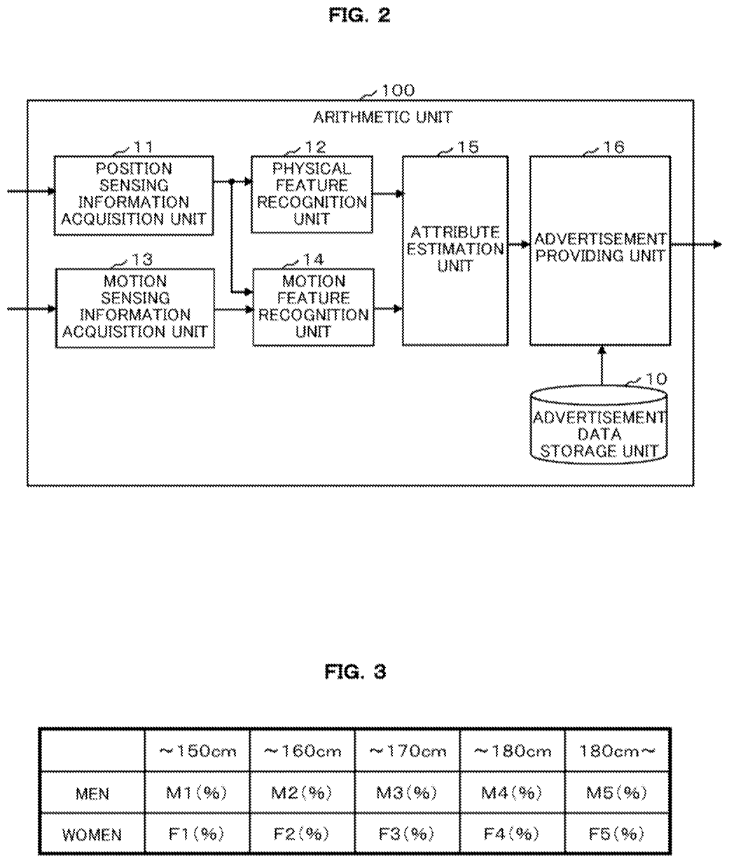

FIG. 2 is a block diagram illustrating an example of the functional configuration of the arithmetic unit 100. As illustrated in FIG. 2, the arithmetic unit 100 includes, as its functional configuration, a position sensing information acquisition unit 11, a physical feature recognition unit 12, a motion sensing information acquisition unit 13, a motion feature recognition unit 14, an attribute estimation unit 15, and an advertisement providing unit 16. The arithmetic unit 100 includes an advertisement data storage unit 10 as a storage medium. It should be noted that the functional blocks 11 to 15 constitute the user attribute estimation device.

The functional blocks 11 to 16 can be configured using any of hardware, a digital signal processor (DSP), and software. For example, in the case in which the functional blocks are configured of software, the functional blocks 11 to 16 are actually configured including a CPU, a RAM, a ROM, and any other component of a computer, and implemented by the operation of a program stored in a recording medium such as a RAM, a ROM, a hard disk, or a semiconductor memory.

The position sensing information acquisition unit 11 acquires a plurality of pieces of position sensing information from the plurality of sensors 400 (position sensing sensors). The position sensing information acquisition unit 11 sequentially acquires position sensing information sequentially transmitted from the position sensing sensor at predetermined time intervals. The position sensing information sent from the position sensing sensor is accompanied by identification information (ID) unique to the individual position sensing sensors.

The physical feature recognition unit 12 recognizes the physical feature of the user body from the plurality of pieces of position sensing information acquired by the position sensing information acquisition unit 11. Specifically, the physical feature recognition unit 12 detects the positions of the parts of the user body from the plurality of pieces of position sensing information acquired by the position sensing information acquisition unit 11, and recognizes the physical feature of the user body from the positions of the parts.

That is, the physical feature recognition unit 12 first detects the position of the head of the user based on the position sensing information acquired from the position sensing sensor mounted on the HMD 200. The physical feature recognition unit 12 detects the positions of the elbow, wrist, waist, knee, and ankle of the user based on the position sensing information acquired from the position sensing sensor attached to the shoulder, elbow, wrist, waist, knee, and ankle of the user. The physical feature recognition unit 12 stores table information in which the correspondence relationship between the ID of the position sensing sensor and the body part is recorded, and can recognize which body part the position sensing information acquired from which position sensing sensor corresponds by referring to the table information.

Subsequently, the physical feature recognition unit 12 recognizes the height of the user from the detected head position. The physical feature recognition unit 12 recognizes the sitting height of the user from the detected head position and waist position. The physical feature recognition unit 12 recognizes the length of the arm of the user from the detected shoulder position and wrist position. The physical feature recognition unit 12 recognizes the length of the leg of the user from the detected waist position and ankle position. The physical feature recognition unit 12 recognizes the joint ratio of the arm (the ratio between the length from the shoulder to the elbow and the length from the elbow to the wrist) from the detected positions of the shoulder, the elbow, and the wrist. The physical feature recognition unit 12 recognizes the joint ratio of the leg (the ratio between the length from the waist to the knee and the length from the knee to the ankle) from the detected positions of the waist, the knee, and the ankle.

When the physical features such as the height, sitting height, arm length, leg length, and joint ratio of the user are recognized as described above, the physical feature recognition unit 12 may recognize the physical features using the positions of the body parts at a certain time point detected based on the position sensing information acquired from each position sensing sensor at the certain time point. However, preferably, the positions of the body parts are detected using the position sensing information acquired from the position sensing sensors at a plurality of time points, and the physical feature is recognized using the positions of the body parts at a plurality of time points. This is because since the user body moves during watching of the VR image, the positions of the body parts detected at a certain time point are not always a value representing the physical feature of the body as it is.

For example, the physical feature recognition unit 12 recognizes the height of the user from the highest position among the positions of the head detected at a plurality of time points. When the user sits down, bends the upper body forward, or bends the upper body backward, the detected position of the head becomes lower than the original height position. To this, the position of the head detected when the user is standing upright is the highest. Therefore, the height of the user is recognized based on the highest position among the positions of the head detected at a plurality of time points, the height of the user can be correctly recognized. It should be noted that it is also thought that the user jumps. Therefore, the height of the user may be recognized by excluding the positions indicating the highest position only for a period shorter than a predetermined time and adopting the positions indicating the highest position continuously for a period longer than the predetermined time.

Similarly, in regard to the sitting height, the physical feature recognition unit 12 uses the highest position among the positions of the head detected at a plurality of time points and uses the highest position among the positions of the waist detected at a plurality of time points to recognize the sitting height of the user from the difference between the positions of the two heights. It should be noted that in regard to the sitting height, the sitting height can be almost correctly recognized from the difference between the position of the head and the position of the waist regardless of the posture of the user as long as the user does not bend the neck. Therefore, the physical feature recognition unit 12 may recognize the sitting height of the user from differences between the position of the head and the position of the waist detected at a plurality of time points, and may adopt the longest length among the lengths.

In regard to the length of the arm, the length of the arm has to be recognized in a state in which the elbow is extended, not in a state in which the elbow is bent. Therefore, the physical feature recognition unit 12 recognizes the length of the arm of the user from the difference between the position of the shoulder and the position of the wrist detected at a plurality of time points, and adopts the longest length among the lengths. The same applies to the length of the leg. The physical feature recognition unit 12 recognizes the length of the leg of the user from the difference between the position of the waist and the position of the ankle detected at a plurality of time points, and adopts the longest length among the lengths. It should be noted that the joint ratio of the arm and the joint ratio of the leg may be recognized from the positions of the shoulder, the elbow, and the wrist and the positions of the waist, the knee, and the ankle detected at a certain time point.

The motion sensing information acquisition unit 13 acquires a plurality of pieces of motion sensing information from the plurality of sensors 400 (motion sensing sensors). The motion sensing information acquisition unit 13 sequentially acquires motion sensing information sequentially transmitted from the motion sensing sensor at predetermined time intervals. The motion sensing information sent from the motion sensing sensor is accompanied by identification information (ID) unique to the individual motion sensing sensors.

The motion feature recognition unit 14 recognizes the motion feature of the user body from the motion sensing information acquired by the motion sensing information acquisition unit 13. Specifically, the motion feature recognition unit 14 detects the motion of each part of the user body from the plurality of pieces of motion sensing information acquired by the motion sensing information acquisition unit 13, and recognizes the motion feature of the user body from the motion of each part. The motion feature recognition unit 14 stores table information in which a correspondence relationship between the ID of the motion sensing sensor and the body part is recorded, and it is possible to recognize which body part the motion sensing information acquired from which motion sensing sensor corresponds by referring to the table information.

The motion feature recognized by the motion feature recognition unit 14 is, for example, a running manner, a hand swing manner, a surrounding looking manner, a standing manner, a sitting manner, and the like of the user. In regard to the manner of running, the motion feature recognition unit 14 recognizes the manner of running from the user's arm swing, leg motion, step length, and the like based on the motion sensing information acquired from the motion sensing sensors attached to the shoulders, elbows, wrists, hips, knees, and ankles. In regard to the manner of hand swing, the motion feature recognition unit 14 recognizes the manner of hand swing from the magnitude, speed, and the like of the motion of hand swing by the user based on the motion sensing information acquired from the motion sensing sensor mounted on the elbow and wrist and the motion sensing sensor mounted on the controller 300.

In regard to how to look around, the motion feature recognition unit 14 recognizes how to look around from the speed at which the user turns the neck and the like based on the motion sensing information acquired from the motion sensing sensor mounted on the HMD 200. In regard to the standing manner, the motion feature recognition unit 14 recognizes the standing manner of the user from whether the user stands with the legs open or stands with the legs closed based on the motion sensing information acquired from the motion sensing sensors attached to the waist, the knee, and the ankle. In regard to the sitting manner, the motion feature recognition unit 14 recognizes the sitting manner of the user from whether the user is sitting with the legs (or) open or sitting with the legs (or) closed based on the motion sensing information acquired from the motion sensing sensors attached to the waist, the knee, and the ankle.

Note that the motion feature recognition unit 14 may recognize the motion feature of the user body based on the positions of the body parts detected from the position sensing information acquired by the position sensing information acquisition unit 11. For example, in regard to the standing manner and the sitting manner, the motion feature recognition unit 14 can recognize the standing manner and the sitting manner of the user based on the position sensing information acquired from the position sensing sensors attached to the waist, the knee, and the ankle.

The attribute estimation unit 15 estimates the user attribute from the physical feature of the user body recognized by the physical feature recognition unit 12 and the motion feature of the user body recognized by the motion feature recognition unit 14. The attributes estimated by the attribute estimation unit 15 are, for example, the gender and the age (time of life) of the user. That is, a certain tendency is seen in physical features such as a height, a sitting height, an arm length, a leg length, and a joint ratio, and in motion features such as a manner of running, a manner of hand swing, a manner of looking around, a manner of standing, and a manner of sitting according to the gender and the age. Thus the gender and the age of the user are estimated based on this tendency.

That is, in regard to physical features such as the height, sitting height, arm length, leg length, and joint ratio, there is a difference in tendency observed for each sex and a difference in tendency observed for each age group. It is possible to estimate the gender and the age of the user based on which tendency the physical features of the body of the user recognized by the physical feature recognition unit 12 correspond to by defining in advance the tendency of the physical features for each gender and age.

For example, the height, sitting height, arm length, leg length, and joint ratio tend to be larger in men than in women. Thus, it is possible to set thresholds for the height, sitting height, arm length, leg length, and joint ratio, and to estimate that the person is male when the value recognized by the physical feature recognition unit 12 is larger than the threshold, and that the person is female when the value is equal to or smaller than the threshold. It is possible to estimate the probability of being male or female by combining which one of male and female is estimated in the height, sitting height, arm length, leg length, and joint ratio. For example, in the case in which a male is estimated in any one of five items of height, sitting height, arm length, leg length, and joint ratio, and a female is estimated in the other four items, a probability of being male is estimated to be 20%, and a probability of being female is estimated to be 80%.

Alternatively, for example, using table information as illustrated in FIG. 3, the height may be classified into a plurality of levels by a plurality of thresholds, and the probability of being male or the probability of being female may be estimated depending on which classification the height recognized by the physical feature recognition unit 12 belongs to. The probability of being male or female at each level of height can be set in advance based on, for example, statistical values of gender related to height. In the example of FIG. 3, M1+F1=100%, M2+F2=100%, . . . . Similarly, the table information is used for the sitting height, the arm length, the leg length, and the joint ratio, and it is possible to estimate the probability of being male or female according to which of the levels classified according to the value range corresponds. Even in the case in which such table information is used, the attribute estimation unit 15 estimates the probability of being male or female by combining the probabilities of male/female estimated for each of height, sitting height, arm length, leg length, and joint ratio.

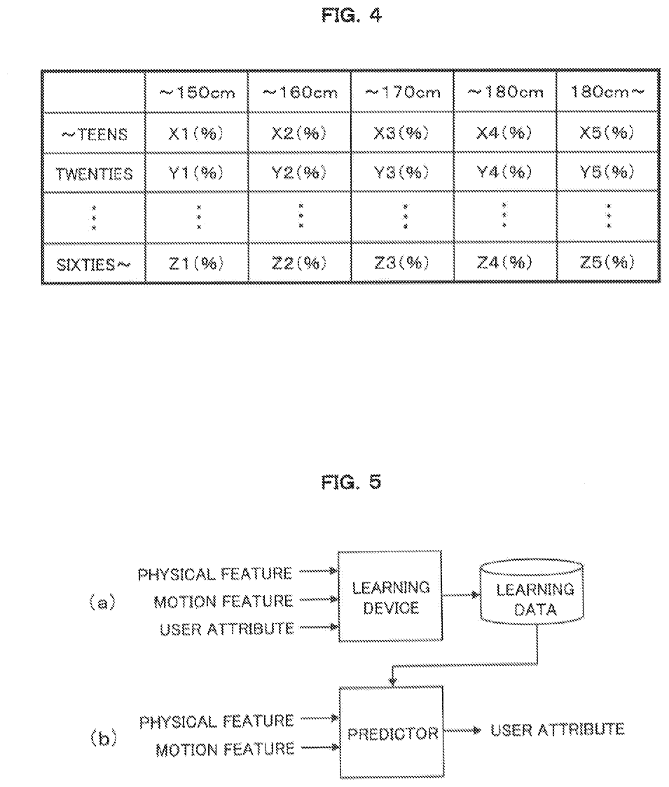

In some of the height, sitting height, arm length, leg length, and joint ratio, an average numerical value for each age group is obtained as statistics. Even in a physical feature for which there is no statistics by age group, it is possible to obtain the average value of physical features by age group or the like by collecting and measuring a certain number of sample users. Thus, for example, it is possible to classify the height into a plurality of levels by a plurality of thresholds using the table information as illustrated in FIG. 4 and estimate the probability of which age group the user belongs to depending on which classification the height recognized by the physical feature recognition unit 12 belongs to. In the example of FIG. 4, X1+Y1+ . . . +Z1=100%, X2+Y2+ . . . +Z2=100%, . . . . The attribute estimation unit 15 similarly uses the table information for the sitting height, the arm length, the leg length, and the joint ratio, and estimates the probability of the age group to which the user belongs depending on which one of the levels classified according to the value range corresponds. The probabilities of ages estimated for each of the height, sitting height, arm length, leg length, and joint ratio are combined to estimate the probability of which age belongs.

There is also a difference in the tendency observed for each sex and a difference in the tendency observed for each age group with respect to the motion features such as the manner of running, the manner of hand swing, the manner of looking around, the manner of standing, and the manner of sitting. It is possible to estimate the gender and the age of the user according to which tendency the user's motion feature recognized by the motion feature recognition unit 14 corresponds by defining in advance the tendency of the motion feature for each gender and age group. The estimation method can be similar to the estimation method based on the physical feature described above.

As described above, the attribute estimation unit 15 can estimate the probabilities of the gender and the age from the physical features of the user body and estimate the probabilities of the gender and the age from the motion features of the user body. The attribute estimation unit 15 further combines the probabilities of the gender and the age estimated from the physical features and probabilities of the gender and the age estimated from the motion features to estimate the final probability of the gender and the age of the user. The attribute estimation unit 15 may estimate the gender and the age group having the highest final probability as the gender and the age group of the user. For example, in the case in which the final probability in regard to the gender of the user is 65% for male and 35% for female, the user is estimated to be male.

It should be noted that although an example of estimating the user attribute by the table method using the threshold is described here, the present invention is not limited to that. For example, as illustrated in FIG. 5, the user attribute may be estimated by a method using machine learning. That is, when learning is performed, the physical features of the body are measured and the motion features of the body are specified for a plurality of sample users whose genders and ages (time of life) are known. Then, as illustrated in FIG. 5(a), machine learning is performed by giving an information set including physical features, motion features, and the known user attributes of the body to the learning device as teacher data, and a learning model is created in which the gender and the age (life of time) are obtained from the output layer when the physical features and motion features of the body are given to the input layer.

Then, when the attribute is estimated for the user whose attribute is unknown, as illustrated in FIG. 5(b), the physical feature recognized by the physical feature recognition unit 12 and the motion feature recognized by the motion feature recognition unit 14 for the user are inputted to the predictor to which the learning model is applied, and the user attribute is estimated as an output from the learning model. Note that the reinforcement learning of the learning model may be performed by giving an actual attribute as correct answer data to the estimation result of the user based on such a learning model and inputting the correct answer data and the physical feature and the motion feature input to the predictor to the learning device.

Based on the user attribute estimated by the attribute estimation unit 15, the advertisement providing unit 16 provides the HMD 200 with a VR advertisement having a content corresponding to the attribute. The data of the VR advertisement to be displayed on the HMD 200 is stored in advance in the advertisement data storage unit 10. The advertisement data storage unit 10 stores advertisement data having different contents depending on the sex and age (life of time). The advertisement providing unit 16 reads advertisement data corresponding to the gender and the age (life of time) of the user estimated by the attribute estimation unit 15 from the advertisement data storage unit 10, and causes the HMD 200 to display the VR advertisement based on the read advertisement data.

As described above in detail, in the present embodiment, a plurality of pieces of position sensing information and a plurality of pieces of motion sensing information are acquired from the sensor 400 worn on the user body and the sensor 400 mounted on the controller 300 held and used by the user, and the physical features of the user body are recognized and the motion features of the user body are recognized. The user attribute is estimated from the recognized physical and motion features of the user body.

According to the present embodiment thus configured, the user attribute is estimated based on the detection information by the sensor 400 mounted on the body of the user wearing the HMD 200 and watching the VR image or the sensor 400 mounted on the controller 300 held by the user. Accordingly, the attribute of the user who is watching the VR image can be estimated even in a place at which no camera is installed. The VR advertisement having a content corresponding to the estimated user attribute can be displayed on the HMD 200.

Note that in the foregoing embodiment, although the attribute estimation unit 15 is described as estimating the user attribute from the physical feature of the user body recognized by the physical feature recognition unit 12 and the motion feature of the user body recognized by the motion feature recognition unit 14, the present invention is not limited to that. For example, the user attribute may be estimated only from the physical feature of the user body recognized by the physical feature recognition unit 12. In this case, the motion sensing information acquisition unit 13 and the motion feature recognition unit 14 are unnecessary.

In the foregoing embodiment, an example is described in which the position sensing sensor is attached to the shoulder, elbow, wrist, waist, knee, and leg using a belt or the like, and the position sensing sensor is also mounted on the HMD 200 and the controller 300. However, it is not necessarily have to install the position sensing sensor at all of these locations. That is, the position sensing information acquisition unit 11 only have to acquire a plurality of pieces of position sensing information from at least one of the position sensing sensor mounted on the user body (including the position sensing sensor mounted on the HMD 200) and the position sensing sensor mounted on the controller 300 held and used by the user.

In the foregoing embodiment, an example is described in which the motion sensing sensor is mounted on the shoulder, elbow, wrist, waist, knee, and leg using a belt or the like, and the motion sensing sensor is also mounted on the HMD 200 and the controller 300. However, it is not necessarily have to install the motion sensing sensor on all of these locations. That is, the motion sensing information acquisition unit 13 only have to acquire motion sensing information from at least one of the motion sensing sensor mounted on the user body (including the motion sensing sensor mounted on the HMD 200) and the motion sensing sensor mounted on the controller 300 held and used by the user.

In the foregoing embodiment, an example is described in which the height, sitting height, arm length, leg length, and joint ratio of the user are recognized as the physical features of the user body. However, it is not necessarily have to recognize all of them. The content of the physical feature to be recognized is not limited to that. Note that it is preferable to recognize more types of physical features from the view point of improving the accuracy of the estimation of the user attribute based on the recognition result.

In the foregoing embodiment, an example is described in which the manner of running, the manner of hand swing, the manner of looking around, the manner of standing, and the manner of sitting of the user are recognized as the motion features of the user body. However, it is not necessarily have to recognize all of the manners. The content of the motion feature to be recognized is not limited to that. Note that it is preferable to recognize more types of motion features from the view point of improving the accuracy of the estimation of the user attribute based on the recognition result.

Furthermore, in the foregoing embodiment, an example of providing a VR advertisement having a content corresponding to the estimated user attribute is described. However, content other than the advertisement may be provided according to the user attribute.

In the foregoing embodiment, an example in which the arithmetic unit 100 is configured as a separate device different from the HMD 200 is described. However, the present invention is not limited to that. That is, a part or all of the functional blocks 10 to 16 included in the arithmetic unit 100 may be included in the HMD 200.

In the foregoing embodiment, a configuration may be provided in which a microphone is further worn on the user body using the HMD 200, a belt, or the like and the arithmetic unit 100 further includes a voice information acquisition unit which acquires the uttered voice information of the user from the microphone, and the attribute estimation unit 15 estimates the user attribute further using the uttered voice information of the user acquired by the voice information acquisition unit.

The foregoing embodiments are merely an example of embodying the present invention, and the technical scope of the present invention should not be interpreted in a limited manner. That is, it is possible to implement the present invention in various forms without departing from the gist or main features of the present invention.

### REFERENCE SIGNS LIST

10 advertisement data storage unit
11 position sensing information acquisition unit
12 physical feature recognition unit
13 motion sensing information acquisition unit
14 motion feature recognition unit
15 attribute estimation unit
16 advertisement providing unit
100 arithmetic unit (user attribute estimation device)
200 HMD
300 controller
400 sensor (position sensing sensor, motion sensing sensor)

1. (canceled)

2. (canceled)

3. (canceled)

4. (canceled)

5. (canceled)

6. (canceled)

7. (canceled)

8. (canceled)

9. A user attribute estimation device comprising:
a position sensing information acquisition unit configured to acquire a plurality of pieces of position sensing information from at least one of a position sensing sensor attached to a body of a user and a position sensing sensor mounted on a controller held and used by the user;
a physical feature recognition unit configured to recognize a plurality of physical features of the body of the user from a plurality of pieces of position sensing information acquired by the position sensing information acquisition unit; and
an attribute estimation unit configured to estimate the user attribute from the plurality of the physical features of the body of the user recognized by the physical feature recognition unit.

10. The user attribute estimation device according to claim 9, wherein the plurality of physical features of the body of the user is at least two of a height, a sitting height, a hand length, a foot length, and a joint ratio of the user.

11. The user attribute estimation device according to claim 9, wherein the physical feature recognition unit recognizes a physical feature of the body of the user based on the position sensing information acquired by the position sensing information acquisition unit at a plurality of time points.

12. The user attribute estimation device according to claim 11, wherein the physical feature recognition unit recognizes a height that is a physical feature of the body of the user based on the position sensing information indicating the highest position continuously for a period longer than a predetermined time among pieces of the position sensing information of a head acquired by the position sensing information acquisition unit at the plurality of time points.

13. The user attribute estimation device according to claim 11, wherein the physical feature recognition unit recognizes a sitting height that is a physical feature of the body of the user based on the position sensing information indicating the highest position among pieces of the position sensing information of a head acquired by the position sensing information acquisition unit at the plurality of time points and the position sensing information indicating the highest position among pieces of the position sensing information of waist acquired by the position sensing information acquisition unit at the plurality of time points.

14. The user attribute estimation device according to claim 11, wherein the physical feature recognition unit calculates a difference between a position of a head and a position of a waist at the plurality of time points based on the position sensing information of the head and the position sensing information of the waist acquired by the position sensing information acquisition unit at the plurality of time points, and the physical feature recognition unit recognizes a value of the largest difference among differences the plurality of time points as a sitting height that is a physical feature of the body of the user.

15. The user attribute estimation device according to claim 11, wherein the physical feature recognition unit calculates a difference between a position of a shoulder and a position of a wrist at the plurality of time points based on the position sensing information of the shoulder and the position sensing information of the wrist acquired by the position sensing information acquisition unit at the plurality of time points, and the physical feature recognition unit recognizes a value of the largest difference among differences at the plurality of time points as a hand length that is a physical feature of the body of the user.

16. The user attribute estimation device according to claim 11, wherein the physical feature recognition unit calculates a difference between a position of a waist and a position of an ankle at the plurality of time points based on the position sensing information of the waist and the position sensing information of the ankle acquired by the position sensing information acquisition unit at the plurality of time points, and the physical feature recognition unit recognizes a value of the largest difference among differences at the plurality of time points as a leg length that is a physical feature of the body of the user.

17. he user attribute estimation device according to claim 9,
further comprising a motion feature recognition unit that recognizes a plurality of motion features of the body of the user from a plurality of pieces of the position sensing information acquired by the position sensing information acquisition unit, and
wherein the attribute estimation unit estimates the user attribute from the plurality of physical features of the user body recognized by the physical feature recognition unit and the plurality of motion features of the body of the user recognized by the motion feature recognition unit.

18. The user attribute estimation device according to claim 17, wherein the plurality of motion features of the body of the user is at least two of a manner of running, a manner of arm swing, a manner of looking around, a manner of standing, and a manner of sitting of the user.
